(19) United States
(12) Patent Application Publication
(10) Pub. No.: US 2015/0015067 A1
(43) Pub. Date: Jan. 15, 2015

(54) CONTROL CIRCUIT AND ELECTRONIC DEVICE USING SAME

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventor: TAO WANG, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/197,257

(22) Filed: Mar. 5, 2014

(30) Foreign Application Priority Data
Jul. 10, 2013 (CN) 2013102877846

(51) Int. Cl. H02J 7/00

(52) U.S. Cl. CPC H02J 7/007; H02J 7/0047
USPC 307/18

(57) ABSTRACT

An electronic device is connected between a power apparatus and an external device for converting a voltage from the power apparatus to charge the external device. The power apparatus is capable of switching between a first state and a second state. The power apparatus generates a working voltage and storing electrical energy in the first state, and stops generating the working voltage in the second state. The electronic device comprises a control circuit and an indication module for indicating the receiving of the working voltage from the power apparatus. The control circuit is connected between the power apparatus and the indication module. When the power apparatus switches from the first state to the second state, the control circuit discharges the stored electrical energy of the power apparatus in the predetermined time and controls the indication module to stop indicating.

### TECHNICAL FIELD

The present disclosure relates to a control circuit and an electronic device with the control circuit.

### DESCRIPTION OF RELATED ART

Using an adapter, most motor vehicles are capable of charging electronic devices such as phones or tablet computers. The motor vehicle includes an alternator and a capacitor connected with the alternator. The alternator provides a working voltage to the adapter when the motor vehicle, example, a car is running, and the capacitor is charged based on the working voltage. The adapter includes a LED for indicating the working state of the adapter. However, when the car engine is suddenly turned off, the alternator stops generating working voltage, but the capacitor discharges and enables the LED to light, therefore, the LED can not truly indicate the state of the adapter.

Therefore, there is room for improvement in the art.

### BRIEF DESCRIPTION OF THE FIGURE

The components of the drawings are not necessarily drawn to scale, the emphasis instead being placed upon clearly illustrating the principles of the embodiment of an electronic device. Moreover, in the drawings, like reference numerals designate corresponding parts throughout several views.

FIG. 1 is a block view of an embodiment of an electronic device.

FIG. 2 is a circuit diagram of an embodiment of the electronic device of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.” The references “a plurality of”and “a number of” mean “at least two.” Embodiments of the present disclosure will be described in detail with reference to the drawings.

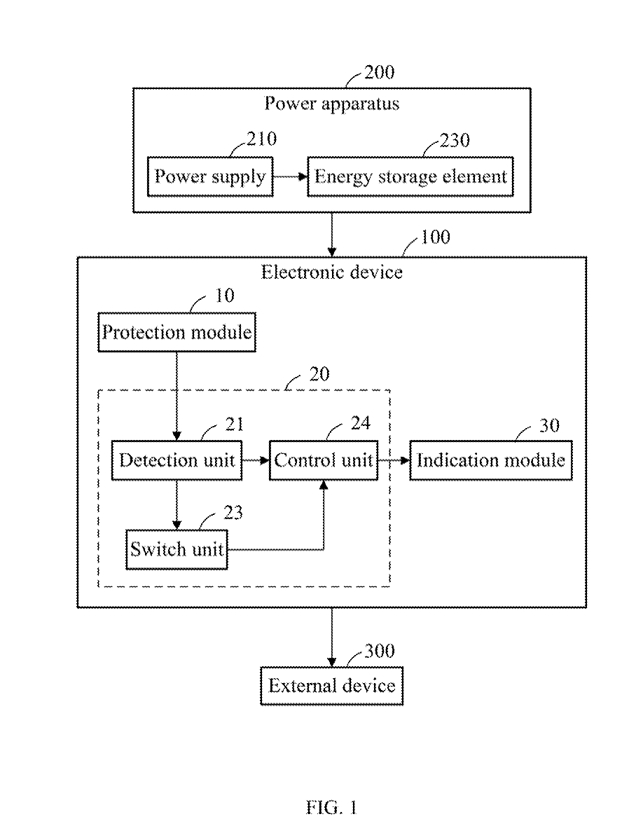

FIG. 1 shows an embodiment of an electronic device 100. The electronic device 100 is electronically connected between a power apparatus 200 and an external device 300, and converts a voltage from the power apparatus 200 to the external device 300 for charging the external device 300. The power apparatus 200 is capable of switching between a first state and a second state. When the power apparatus 200 is in the first state, the power apparatus 200 outputs a constant working voltage to the electronic device 100 and stores electrical energy based on the working voltage. When the power apparatus 200 is in the second state, the power apparatus 200 stops generating the working voltage, and the electronic device 100 discharges the stored electrical energy of the power apparatus 200 in a predetermined time. In the embodiment, the electronic device 100 is an adapter, the power apparatus 200 is a car, and the external device 300 can be a phone or a tablet computer, for example. The first state is a power-off state, and the second state is a power-on state. The predetermined time is 0.68 seconds.

The electronic device 100 includes a protection module 10, a control circuit 20, and an indication module 30.

The protection module 10 is electronically connected between the power apparatus 100 and the control circuit 20. The protection module 10 detects whether a current passing through the protection module 10 is greater than a predetermined value. When the current is greater than the predetermined value, the protection module 10 cuts off the electrical connection between the power apparatus 200 and the control circuit 20.

The control circuit 20 is electronically connected between the protection module 10 and the indication module 30. The control circuit 20 forms a discharge path for discharging the electrical energy of the power apparatus 200 when the power apparatus 200 is in the second state, and generates a charging voltage to the external device 30 when the power apparatus 200 is in the first state. The control circuit 20 includes a detection unit 21, a switch unit 23, and a control unit 24. The detection unit 21, the switch unit 23, and the control unit 24 are connected between the protection module 10 and the indication module 30.

The detection unit 21 is connected to the protection module 10. The detection unit 21 receives a working voltage from the power apparatus 200 and detects whether the working voltage is less than a predetermined value. When the working voltage is less than the predetermined value, the detection unit 21 generates a connecting signal to the switch unit 23, and stops providing a driving voltage to the control unit 24. When the working voltage is greater than or equal to the predetermined value, the detection unit 21 generates a cutting signal to the switch unit 23, and generates the driving voltage to the control unit 24. In one embodiment, the predetermined value is 11.1 volts. The connecting signal is a logic-low signal, and the cutting signal is a logic-high signal.

The power apparatus 200 includes an energy storage element 230. The switch unit 23 is connected between the detection unit 21 and the control unit 24. The switch unit 23 establishes a discharge path with the energy storage element 230 and the detection unit 21 for discharging the electrical energy stored by the energy storage element 230 in response to the connecting signal. The switch unit 23 further cuts off the discharge path in response to the cutting signal.

The control unit 24 is connected between the detection unit 21 and the indication module 30. The control unit 24 generates a first control signal based on the driving voltage, and generates a second control signal when control unit 24 does not receive the driving voltage. In one embodiment, the first control signal is a logic-high signal, and the second control signal is a logic-low signal.

The indication module 30 generates indication information for indicating that the electronic device 100 receives voltage from the power apparatus 200 in response to the first control signal, and stops generating the indication information in response to the second control signal. In one embodiment, the indication information is an illuminated lamp.

The power apparatus 200 further includes a power supply 210.

The power supply 210 provides a constant working voltage. In one embodiment, the power supply 210 is an alternator, and the constant working voltage is 12 volt (t).

The energy storage element 230 is connected to the power supply 210. The energy storage element 230 charges up to store electrical energy based on the working voltage, and discharges in the predetermined time from the time point when the electronic device 100 does not receive the driving voltage. In one embodiment, the electrical energy is discharged during the predetermined time.

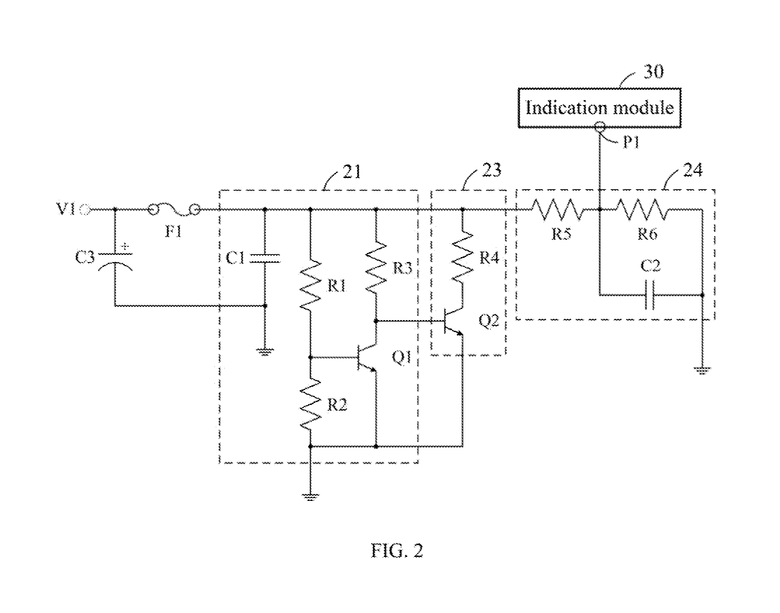

FIG. 2 shows that the protection module 10 includes a fuse F1. Opposite terminals of the fuse Fl are respectively connected to the power supply 210 and the detection unit 21.

The detection unit 21 includes a first transistor Q1, a first resistor R1, a second resistor R2, a third resistor R3, and a first capacitor C1. A base of the first transistor Q1 is connected to the fuse F1 through the first resistor R1. An emitter of the first transistor Q1 is grounded. A collector of the first transistor Q1 is connected to the fuse F1 through the third resistor R3. A terminal of the second resistor R2 is connected to the fuse F1. An opposite terminal of the second resistor R2 is grounded. A terminal of the first capacitor C1 is connected to the fuse F1. An opposite terminal of the first capacitor C1 is grounded. In one embodiment, the first transistor Q1 is an npn type bipolar junction transistor.

The switch unit 23 includes a second transistor Q2 and a fourth resistor R4. A base of the second transistor Q2 is connected to the collector of the first transistor Q1. An emitter of the second transistor Q2 is grounded. A collector of the second transistor Q2 is connected to the fuse through the fourth resistor R4. The resistance of the fourth resistor R4 is less than the resistances of the first resistor R1, the second resistor R2, and the third resistor R3. In one embodiment, the transistor Q2 is an npn type bipolar junction transistor. The resistance of the fourth resistor R4 is 1 k ohm.

The control unit 24 includes a first limiting resistor R5, a second limiting resistor R6, and a second capacitor C2. A terminal of the first limiting resistor R5 is connected to the fuse F1. Opposite terminal of the first limiting resistor R5 is grounded through the second limiting resistor R6.

The indication module 30 includes a control pin P1. The control pin P1 is connected between the first limiting resistor R5 and the second limiting resistor R6.

The power supply 210 includes a power source V1. The power source V1 is connected to the fuse F1.

The energy storage element 230 is a third capacitor C3. An anode of the third capacitor C3 is connected between the power source V1 and the fuse F1. In one embodiment, the third capacitor C3 is an electrolytic type capacitor, and the capacitance of the third capacitor C3 is 680 μf.

A working method of the protection circuit 300 is described as follow. When the power apparatus 200 is in the second state, the power source V1 outputs the constant working voltage. The third capacitor C3 is charged up to store electrical energy by the working voltage. The voltage difference between the base and the emitter of the first transistor Q1 is greater than 0.7 volts, the first transistor Q1 turns on, which cause the base of the second transistor Q1 to be grounded. The voltage difference between the base and the emitter of the second transistor Q2 is less than 0.7 volts, the second transistor Q2 turns off. The first limiting resistor R5 and the second limiting resistor R6 divide the working voltage, the control pin P1 receives the logic-high signal, and the indication module 30 generates the indication information.

When the power apparatus 200 switches to the first state, the power source V1 stops generating the working voltage, which causes the third capacitor C3 to discharge in the predetermined time. When the voltage difference between the base and the emitter of the first transistor Q1 is less than 0.7 volts, the first transistor Q1 turns off The voltage difference between the base and the emitter of the second transistor Q2 is more than 0.7 volts, the second transistor turns on, which cause the fuse F1, the fourth resistor R4 and the second transistor to form a discharge path for discharging the electrical energy stored by the third capacitor C3. After the predetermined time, the stored electrical energy is completely discharged and the control pin P1 receives a logic-low signal. The predetermined time is calculated according to the following formula: T=R4*C3=680 μf*1 KΩ=0.68S. The indication module 30 stops generating the indication information.

In use, when the power apparatus 200 is powered off, the electrical energy stored by the power apparatus 200 is quickly discharged by electronic device 100. Therefore, the indication function of the electronic device 100 is improved.

While various exemplary and preferred embodiments have been described, the disclosure is not limited thereto. On the contrary, various modifications and similar arrangements (as would be apparent to those skilled in the art) are intended to also be covered. Therefore, the scope of the appended claims should be accorded the broadest interpretation so as to encompass all such modifications and similar arrangements.

What is claimed is:

1. An electronic device connected between a power apparatus and an external device for converting a voltage from the power apparatus to charge the external device, the power apparatus capable of switching between a first state and a second state; the power apparatus generating a working voltage and storing electrical energy in the first state, and stopping generating the working voltage in the second state; the electronic device comprising:
a control circuit connected to the power apparatus; and
an indication module connected to the control circuit for indicating receiving the working voltage from the power apparatus;
wherein when the power apparatus switches from the first state to the second state, the control circuit discharges the stored electrical energy of the power apparatus in a predetermined time and controls the indication module to stop indicating.

2. The electronic device of claim 1, wherein when the power apparatus generates a working voltage in the first state, the control circuit controls the indication module to output indication information for indicating receiving the working voltage from the power apparatus.

3. The electronic device of claim 1, wherein the control circuit comprises a detection unit and a switch unit; the detection unit receives the voltage from the power apparatus and detects whether the received voltage is less than a predetermined value; when the received voltage is less than the predetermined value; the detection unit generates a connecting signal; the switch unit turns on and forms a discharge path with the detection unit for discharging the stored electrical energy in the predetermined time in response to the connecting signal.

4. The electronic device of claim 3, wherein when the received voltage is greater than or equal to the predetermined value, the detection unit generates a cutting signal; the switch unit cuts off the discharge path in response to the cutting signal.

5. The electronic device of claim 3, wherein the detection unit comprises a first transistor, a first resistor, a second resistor, and a third resistor; a base of the first transistor is connected to the power apparatus through the first resistor, an emitter of the first transistor is grounded; a collector of the first transistor is connected to the power apparatus through the third resistor; a terminal of the second resistor is connected to the power apparatus, an opposite terminal of the second resistor is grounded.

6. The electronic device of claim 3, wherein the switch unit comprises a second transistor and a fourth resistor; a base of the second transistor is connected to detection unit; an emitter of the second transistor is grounded; a collector of the second transistor is connected to the power apparatus through the fourth resistor.

7. The electronic device of claim 3, wherein the control circuit further comprises a control unit; when the received voltage is greater than the predetermined value, the detection unit further generates a driving voltage to the control unit; the control unit controls the indication module to generate indication information.

8. The electronic device of claim 7, wherein when the received voltage is less than or equal to the predetermined value, the detection unit stops generating the driving voltage to the control unit; the control unit controls the indication module to stop generating the indication information.

9. The electronic device of claim 1, wherein the electronic device further comprises a protection module; the protection module is connected between the power apparatus and the control circuit; the protection module detects whether a current passing through the protection module is more than a predetermined value; when the current is more than the predetermined value, the protection module cuts off the connection between the power apparatus and the control circuit.

10. A control circuit connected between a power apparatus and an indication module; the power apparatus capable of switching between a first state and a second state; the power apparatus generating a working voltage and storing electrical energy in the first state; the indication module for indicating receiving the working voltage from the power apparatus; the control circuit comprising:
a detection unit receiving the working voltage from the power apparatus and detecting whether the received voltage is greater than a predetermined value; and
a switch unit connected between the detection unit and the indication module;
wherein when the received voltage is less than or equal to the predetermined value, the detection unit generates a connecting signal; the switch unit turns on and forms a discharge path with the detection unit for discharging the stored electrical energy in a predetermined time in response to the connecting signal.

11. The control circuit of claim 10, wherein when the received voltage is greater than or equal to the predetermined value, the detection unit generates a cutting signal; the switch unit cuts off the discharge path in response to the cutting signal.

12. The control circuit of claim 10, further comprising a control unit; wherein when the received voltage is greater than the predetermined value, the detection unit further generates a driving voltage to the control unit; the control unit controls the indication module to generate indication information; when the received voltage is less than or equal to the predetermined value, the detection unit stops generating the driving voltage, and the control unit controls the indication module to stop generating indication information.

13. The control circuit of claim 10, wherein the detection unit comprises a first transistor, a first resistor, a second resistor, and a third resistor; a base of the first transistor is connected to the power apparatus through the first resistor, an emitter of the first transistor is grounded; a collector of the first transistor is connected to the power apparatus through the third resistor; a terminal of the second resistor is connected to the power apparatus, an opposite terminal of the second resistor is grounded.

14. The control circuit of claim 10, wherein the switch unit comprises a second transistor and a fourth resistor; a base of the second transistor is connected to detection unit; an emitter of the second transistor is grounded; a collector of the second transistor is connected to the power apparatus through the fourth resistor.
